(19) United States
(12) Patent Application Publication
(10) Pub. No.: US 2013/0265922 A1
(43) Pub. Date: Oct. 10, 2013

(54) APPARATUS AND METHOD OF MANAGING A POWER SAVING REQUEST

(71) Applicant: QUALCOMM INCORPORATED, San Diego, CA (US)

(72) Inventors: Chetan G. Chakravarthy, San Diego, CA (US); Arvindhan Kumar, San Diego, CA (US); Kaliki Chaitanya Reddy, San Diego, CA (US)

(73) Assignee: QUALCOMM Incorporated, San Diego, CA (US)

(21) Appl. No.: 13/692,528

(22) Filed: Dec. 3, 2012

Related U.S. Application Data
(60) Provisional application No. 61/621,860, filed on Apr. 9, 2012.

(51) Int. Cl. H04W 52/02

(52) U.S. Cl. CPC H04W 52/0209
USPC 370/311

(57) ABSTRACT

Apparatus and method for wireless communication in a wireless communication network includes receiving a power saving request from an application on a wireless device and determining whether the wireless device has data waiting for transmission in response to the received power saving request. The apparatus and method also includes starting a buffer timer when the data waiting for transmission is determined to exist, buffering the power saving request until expiration of the buffer timer, and triggering transmission of a dormancy request to a network component based on whether the data waiting for transmission is determined to exist.

### CROSS-REFERENCES TO RELATED APPLICATIONS

This application claims the benefit of U.S. Provisional Application No. 61/621,860 filed Apr. 9, 2012.

### BACKGROUND

1. Field

Aspects of the present disclosure relate generally to wireless communication systems, and more particularly, to management of power savings on a wireless communication device.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

The fast evolving mobile communication technologies and their intent to meet the high data centric demands of the customers have invariantly paid the price of battery drain on the mobile terminal, otherwise referred to as user equipment (UE). Accessibility to wide-ranged data centric applications for modern mobile terminals contributes equally to the power hungry nature of smartphones. All these factors have chipped in and have motivated standard bodies to also work on new features that would help conserve the mobile battery power. In some cases, the triggering of these features has been granted to the applications that drive the need of data resources.

For example, varied applications and their bursty data requests can generate requests from the mobile terminal to move the mobile terminal to a power saving state, and the underlying radio access technology communicates the requirements to the core network. To have a check on increasing the amount of such back to back requests from a particular mobile terminal, which may increase the signaling overhead, the protocol may place a constraint to limit or time the requests. These types of features provide an opportunity for optimization in terms of choosing when exactly to make such requests.

### SUMMARY

A method of method of managing a power saving request is offered. The method includes receiving a power saving request from an application on a wireless device and determining whether the wireless device has data waiting for transmission in response to the received power saving request. The method also includes starting a buffer timer when the data waiting for transmission is determined to exist, buffering the power saving request until expiration of the buffer timer, and triggering transmission of a dormancy request to a network component based on whether the data waiting for transmission is determined to exist.

An apparatus of managing a power saving request is offered. The apparatus includes receiving a power saving request from an application on a wireless device and determining whether the wireless device has data waiting for transmission in response to the received power saving request. The apparatus also includes starting a buffer timer when the data waiting for transmission is determined to exist, buffering the power saving request until expiration of the buffer timer, and triggering transmission of a dormancy request to a network component based on whether the data waiting for transmission is determined to exist.

### BRIEF DESCRIPTION OF THE DRAWINGS

FIG. 1 is a schematic diagram of one aspect of a system for managing a power saving request.

FIG. 2 is a schematic diagram of another aspect of a system for managing a power saving request.

FIG. 3 is a schematic diagram of another aspect of the user equipment of FIG. 1.

FIG. 4 is a flowchart of one aspect of a method of managing a power saving request.

FIG. 5 is a flowchart of another aspect of a method of managing a power saving request.

FIG. 6 is a message flow diagram of one aspect of a message exchange for managing power saving requests.

FIG. 7 is a flowchart of another aspect of a method of managing a power saving request.

FIG. 8 is a block diagram illustrating an example of a hardware implementation for an apparatus employing a processing system.

FIG. 9 is a block diagram conceptually illustrating an example of a telecommunications system.

FIG. 10 is a conceptual diagram illustrating an example of an access network.

FIG. 11 is a conceptual diagram illustrating an example of a radio protocol architecture for the user and control plane.

FIG. 12 is a block diagram conceptually illustrating an example of a Node B in communication with a UE in a telecommunications system.

Note, a component in any figure represented within dashed lines may be an optional component.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

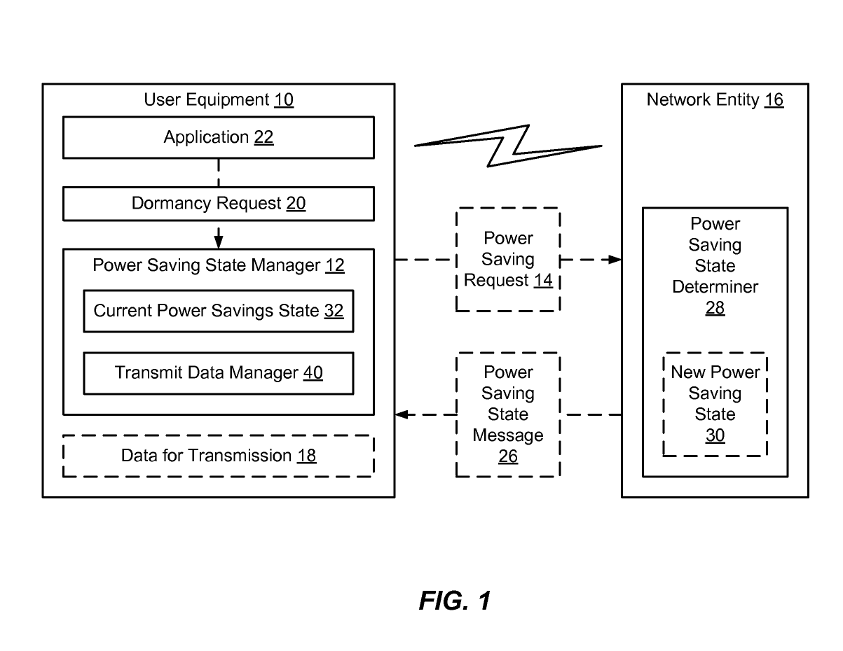

Referring to FIG. 1, in one aspect, a mobile terminal or user equipment (UE) 10 having improved power and/or communication overhead savings includes a power saving state manager 12 configured to control the generation of a power saving request 14 to a network entity 16, such as a NodeB, based on existence of data for transmission 18 at UE 10. In particular, power saving state manager 12 may receive a dormancy request 20 from an application 22 on UE 10. It should be noted that, in some aspects, dormancy request 20 from application 22 may also be referred to as a “power saving request.” Typically, in the prior art, dormancy request 20 would trigger transmission of power saving request 14 unless a dormancy request timer is active (initialized by a prior dormancy request to prevent multiple back-to-back request transmissions).

In the present aspects, however, in response to receiving dormancy request 20, power saving state manager 12 checks UE 10 to determine if any data for transmission 18 is available and waiting to be transmitted. For example, in an aspect, power saving state manager 12 may execute a transmit data manager 40 to check, for example, transmit buffers of UE 10 in order to determine whether any UE 10 data for transmission 18 exists on UE 10. In some aspects, for instance, transmit data determiner 24 may reside at one protocol layer and check other protocol layers for existence of data for transmission 18. In another aspect, for instance, data for transmission may correspond to a single packet data protocol (PDP) context, or to more than one PDP context of UE 10. Note, a PDP context is the connection or link between a mobile device and a network server that allows them to communicate with each other, in other words a session. Therefore, if data for transmission 18 exists, then power saving state manager 12 buffers dormancy request 20 for a time period in order to allow for all or a portion of data for transmission 18 to be transmitted. If data for transmission 18 does not exist, then power saving state manager 12 may initiate generation and transmission of power saving request 14 to network entity 16. In some cases, however, power saving state manager 12 may not trigger transmission of power saving request 14 until after a dormancy request timer has expired. In an aspect, for example in UMTS Release 8 Fast Dormancy, power saving request 14 may be a signaling connection release indication (SCRI) message with a special case ‘UE Requested PS Data session end’ transmitted to request a better power saving state.

For instance, instead of just releasing the signaling connection when it desires the UE 10 has to wait for the expiration of a network configured timer (T323). Once the timer expires, the UE 10 can send a signaling connection release indication message with a new parameter that indicates “UE requested PS data session end”. At this point the network entity 16 can then decide to do nothing, to release the mobile to Idle or to put the connection into Cell-/URA-PCH state.

In any case, network entity 16 may receive power saving request 14 and generate a power saving state message 26 that defines a new power saving state 30 for UE 10. For example, in an aspect, network entity 16 may execute a power saving state determiner 28, which includes a power saving state algorithm that selects a predefined power saving state, or that determines a power saving state, e.g. based on UE and/or network characteristics, to use as new power saving state 30 in response to power saving request 14. In some aspects, for example in UMTS Release 8, new power saving state 30 may be one of IDLE, CELL_PCH, URA_PCH, or CELL_FACH. UE 10 may then receive power saving state message 26, execute power saving state manager 12 to identify new power saving state 30 defined in message 26, and update current power saving state 32 to correspond to new power saving state 30.

The described aspects of power saving state manager 12 may be used to optimize management of dormancy request 20 to improve the efficiency of UE 10 by reducing unnecessary communications with network entity 16, such as when data for transmission 18 exists. Additionally, the described aspects of power saving state manager 12 may be used to optimize management of dormancy request 20 to improve the efficiency of UE 10 transitioning into a reduced power state by eliminating unnecessary ping-ponging between states caused in the prior art by transmission of power saving request 14 when data for transmission 18 exists in the transmit buffers of UE 10.

Thus, the apparatus of FIG. 1 illustrates data flow between different components/modules/means within the apparatus. The apparatus may include module/component/means application 22, dormancy request 20, power saving manager 12, transmit data manager 40, and power saving state determiner 28 configured to carry out the stated processes/algorithm. The apparatus may also include current power savings state 32, data for transmission 18, and new power savings state 30 configured to store values to carry out the stated processes/algorithm.

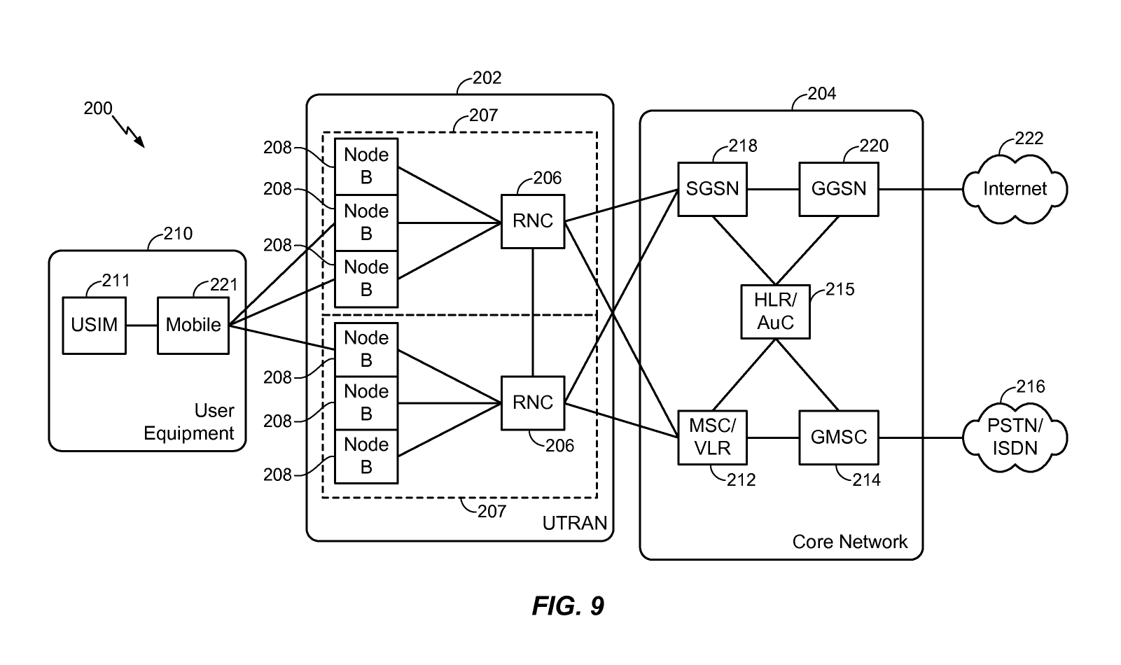

Note, the components/modules/means may be hardware components specifically configured to carry out the stated processes/algorithm, implemented by a processor configured to perform the stated processes/algorithm, stored within a computer-readable medium for implementation by a processor, or some combination thereof will be discussed in more detail with regards to FIG. 9.

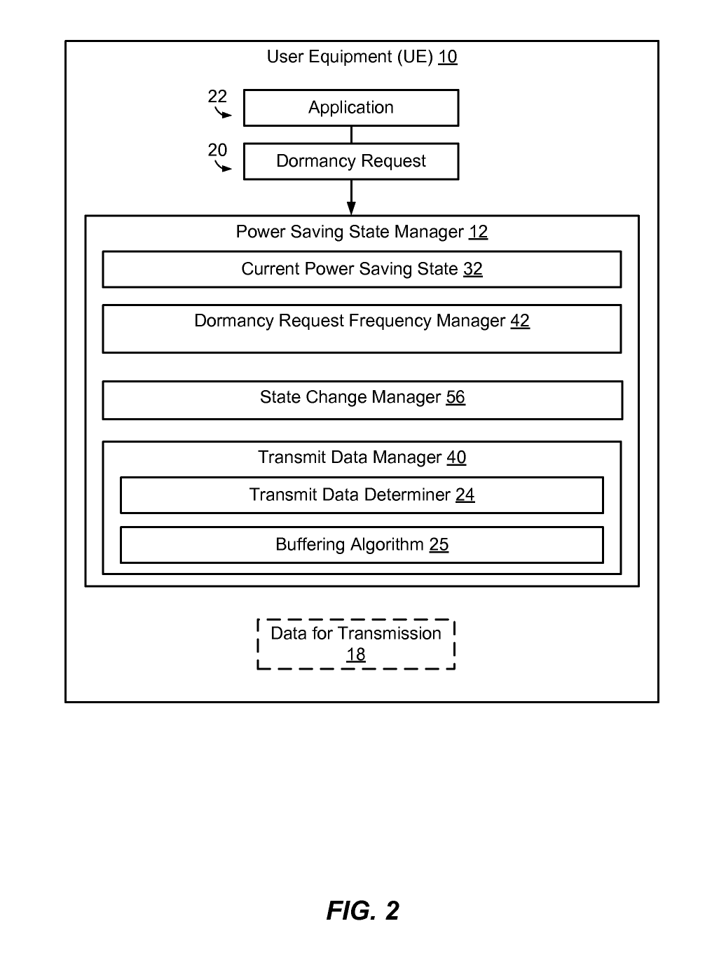

Referring to FIG. 2, in a more detailed aspect, UE 10 and power saving state manager 12 may be configured to include a transmit data manager 40 and a dormancy request frequency manager 42 to manage dormancy request 20 from application 22 and buffer dormancy request 20 based on the existence of data for transmission 18.

For instance, after power saving state manager 12 receives a dormancy request 20, the transmit data manager 40 may then execute the transmit data determiner 24 to determine if there is data for transmission on the UE 10. In other words, the transmit data determiner 24 checks the checks is there data on data for transmission 18 of UE 10.

When the transmit data determiner 24 determines that there is data on data for transmission 18, the transmit data manager 40 executes a buffering algorithm 25 such that the dormancy request 20 is moved to a buffer.

Alternatively, when the transmit data determiner 24 determines that there is no data on data for transmission 18, the transmit data manager 40 may notify the dormancy request frequency manager 42 to control the frequency of transmitting power saving requests 14 to network entity 16 (FIG. 1).

Power saving sate manager 12 may additionally include a state change manager 56 configured to change the current power saving state 32 of UE 10. For instance, the state change manager 56 may be capable of receiving a power saving message and change the power saving state of UE 10 via changing the current power saving state 32 of the UE 10. The state change manager 56 may change the power saving state of the UE 10 to a active mode, idle mode, a standby mode, or even a periodic active mode based on the need of the UE 10 relative to the network 16.

Thus, in an aspect, UE 10 may be configured to manage a dormancy request 20 from application 22 in order to buffer the request when data for transmission 18 is determined to exist, thereby saving communication resources and more efficiently manage the power saving states of UE 10.

Thus, the apparatus of FIG. 2 illustrates data flow between different components/modules/means within the apparatus. The apparatus may include module/component/means application 22, dormancy request 20, power saving manager 12, dormancy request frequency manager 42, state change manager 56, transmit data manager 40, and transmit data determiner 24 configured to carry out the stated processes/algorithm. The apparatus may also include current power savings state 32, buffer algorithm 25, and data for transmission 18 configured to store values to carry out the stated processes/algorithm.

Note, the components/modules/means may be hardware components specifically configured to carry out the stated processes/algorithm, implemented by a processor configured to perform the stated processes/algorithm, stored within a computer-readable medium for implementation by a processor, or some combination thereof will be discussed in more detail with regards to FIG. 9.

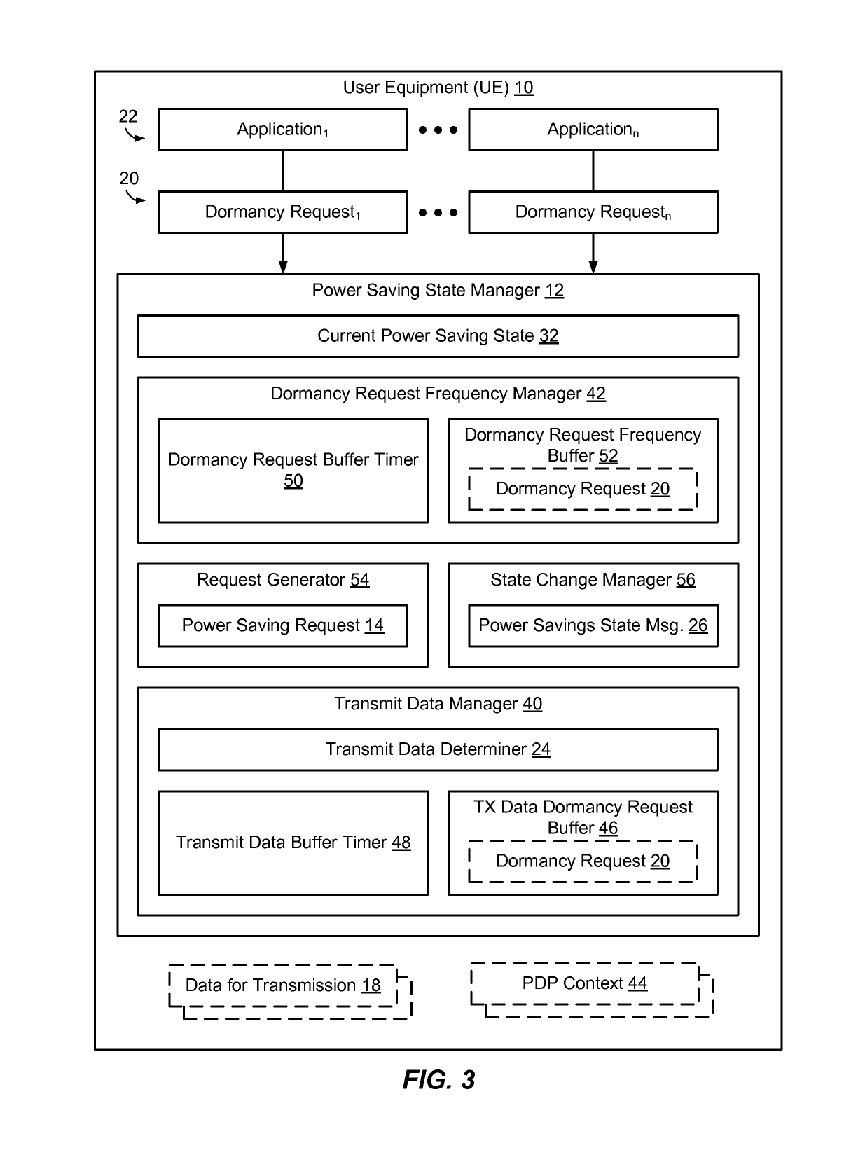

Referring to FIG. 3, in still a more detailed aspect, UE 10 and power saving state manager 12 may be configured to include a transmit data manager 40 and a dormancy request frequency manager 42, respectively, to account for a plurality of dormancy requests 20 from a plurality of applications 22 and buffer one or more dormancy requests 20 based on existence of data for transmission 18 and/or based on a prior dormancy request 20.

For example, in an aspect, power saving state manager 12 may receive dormancy request 20 and execute a transmit data manager 40 to control handling of the received dormancy request 20. In particular, data transmit manager 40 may execute transmit data determiner 24 to check for data for transmission 18 on UE 10. Specifically, transmit data determiner 24 may perform an inter-protocol layer check, which may be a higher layer (e.g. RRC layer) querying a lower layer (e.g. layer 2, include RLC layer) or vice versa, for data for transmission 18 associated with one or more PDP contexts 44, e.g. with a same PDP context and/or with any or all PDP contexts on UE 10. In others words, the transmit data determiner 24 may be configured to determine whether the data waiting for transmission 18 has a corresponding PDP context.

When transmit data determiner 24 discovers data for transmission 18, then transmit data manager 40 executes a buffering algorithm wherein the received dormancy request 20 is moved to a dormancy request buffer 46 and a transmit data buffer timer 48 is activated. Transmit data timer 48 may have a fixed or dynamic expiration period, e.g. based on an operator setting, an amount of data for transmission 18, an expected time to transmit data for transmission 18, or any other variables associated with transmitting data from UE 10. Upon expiration of transmit buffer timer 48, transmit data manager 40 again may execute transmit data determiner 24 to check UE 10 for existence of data for transmission 18, and repeat the buffering process again if data is available.

Alternatively, when transmit data manager 40 determines that data for transmission 18 does not exist, either initially in response to dormancy request 20 or after buffering of dormancy request 29, then transmit data manager 40 may notify dormancy request frequency manager 42 to control the frequency of transmitting power saving requests 14 (FIG. 1) to network entity 16. In particular, dormancy request frequency manager 42 may maintain a dormancy request buffer timer 50 to maintain a minimum time period between transmissions of power saving requests 14. For example, in some aspects, such as in UMTS Release 8 Fast Dormancy, dormancy request buffer timer 50 may be referred to as a T323 timer. Specifically, upon receipt of a first-in-time dormancy request 20, dormancy request frequency manager 42 may activate dormancy request buffer timer 50, and upon receipt of a second-in-time dormancy request 20, dormancy request frequency manager 42 checks whether or not dormancy request buffer timer 50 is active, and if so, places the second-in-time dormancy request 20 in dormancy request buffer 52 until expiration of dormancy request buffer timer 50. Note, the dormancy request 20 (an optional aspect, as denoted by the dotted lines) in the dormancy request buffer 52 may refer to the second-in-time dormancy request when the dormancy request buffer timer 50 is active. Once dormancy request buffer timer 50 expires, dormancy request frequency manager 42 notifies transmit data manager 40 of the second-in-time dormancy request 20, and transmit data manager 40 performs as discussed above to check for data for transmission 18 once again.

When dormancy request buffer timer 50 is not active, then dormancy request frequency manager 42 notifies and/or executes request generator 54 to generate power saving request 14 and initiate transmission to network entity 16 (FIG. 1). For example, dormancy request frequency manager 42 may receive second-in-time dormancy request 20 after expiration of dormancy request buffer timer 50 that was triggered by first-in-time dormancy request 20, e.g. either when dormancy request frequency manager 42 is first notified of second-in-time dormancy request 20 from transmit data manager 40, or after dormancy request frequency manager 42 has already buffered second-in-time dormancy request 20.

Power saving state manager 12 may further include a state change manager 56 configured to change settings corresponding to current power saving state 32 of UE 10. For example, state change manager 56 may receive power saving state message 26 and detect or otherwise extract new power saving state 30 determined by network entity 16 in response to power saving request 14. For instance, state change manager 56 may change current power saving state 32 from an active mode, where communication channels are established and maintained, to an idle mode, where UE 10 terminates communication channels and only periodically monitors for pages in order to save power, e.g., to increase a time period that UE 10 can function on a given level of charge in a battery that powers UE 10. In other aspects, for example in UMTS Release 8, state change manager 56 may changes current power saving state 32 to one of IDLE, CELL_PCH, URA_PCH, or CELL_FACH.

Thus, in an aspect, UE 10 manages multiple dormancy requests 20 from multiple applications 22 in order to buffer requests when data for transmission 18 is determined to exist, and to maintain a minimum time period between power saving requests 14, thereby saving communication resources and more efficiently managing the power saving states of UE 10.

Thus, the apparatus of FIG. 3 illustrates data flow between different components/modules/means within the apparatus. The apparatus may include module/component/means application 22, dormancy request 20, power saving manager 12, dormancy request frequency manager 42, request generator 54, state change manager 56, transmit data manager 40, and transmit data determiner 24 configured to carry out the stated processes/algorithm. The apparatus may also include current power savings state 32, dormancy request buffer timer 50, dormancy request frequency buffer 52, power saving request 14, power savings state message 26, transmit data buffer timer 48, TX data dormancy request buffer 46, data for transmission 18, and PDP context 44 configured to store values to carry out the stated processes/algorithm.

Note, the components/modules/means may be hardware components specifically configured to carry out the stated processes/algorithm, implemented by a processor configured to perform the stated processes/algorithm, stored within a computer-readable medium for implementation by a processor, or some combination thereof will be discussed in more detail with regards to FIG. 9.

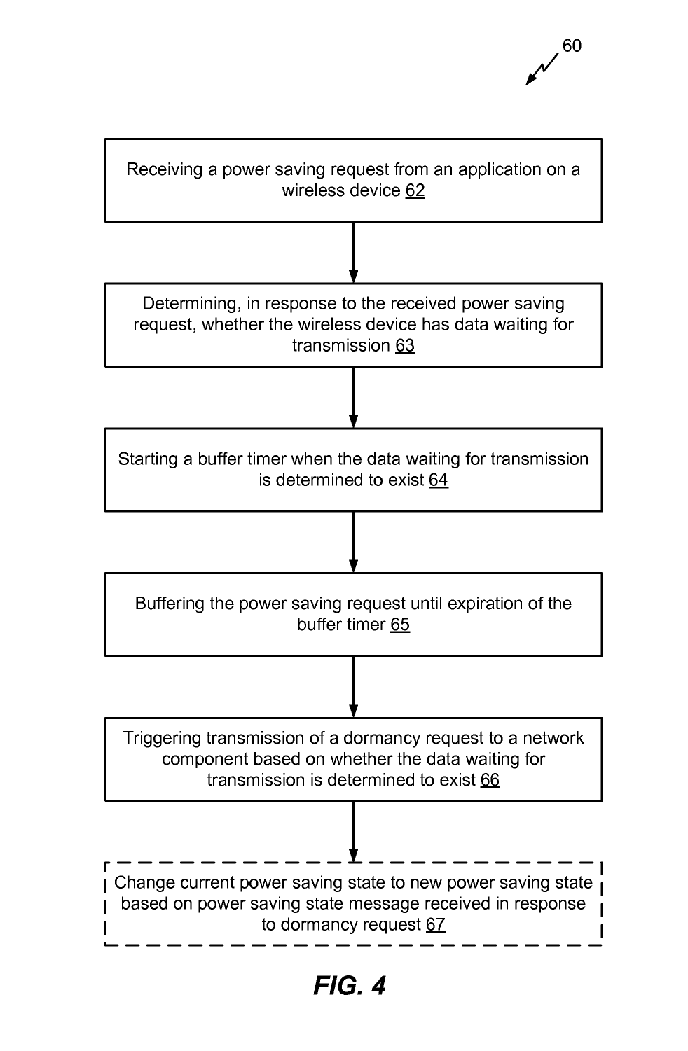

Referring to FIG. 4, in operation, one aspect of a method 60 of managing power saving requests includes receiving a power saving request from an application on a wireless device (Block 62). For example, in an aspect, UE 10 (FIG. 1) or a component thereof, such as power saving state manager 12, receives dormancy request 20 from application 22, such as based on data inactivity at application 22. For instance, dormancy request 20 may be transmitted to power saving state manager 12 through protocol layers or via a communication bus. In another aspect, the dormancy request frequency buffer 52 (FIG. 3) receives a second-in-time dormancy request 20 when the dormancy request buffer timer 50 is active due to a first-in-time dormancy request.

Further, method 60 includes determining, in response to the received power saving request, whether the wireless device has data waiting for transmission (Block 63). For example, power saving state manager 12 (FIG. 1) may execute a transmit data determiner 24 (FIGS. 2 and 3) to detect any data for transmission 18 on UE 10. For instance, in an aspect, transmit data determiner 24 may be an entity at one protocol layer, associated with one or more PDP contexts of UE 10, and may query one or more other protocol layers for data available in corresponding transmit buffers. For example, transmit data determiner 24 may be an RRC protocol layer entity that queries a layer 2, e.g. an RLC protocol layer entity, for data available in an RLC layer transmit buffer. The results of the detecting or querying provide transmit data determiner 24 with information on whether data for transmission 18 exists or does not exist, for one or more PDP contexts.

Moreover, in some aspects, method 60 may include starting a buffer timer when the data waiting for transmission is determined to exist (Block 64) and buffering the power saving request until expiration of the buffer timer (Block 65). For example, when transmit data determiner 24 discovers existence of data for transmission 18, such as in a reply to a query to a protocol layer, transmit data manager 40 (FIG. 3) may start a transmit data buffer timer 48 and store dormancy request 20 in dormancy request buffer 46 until the expiration of transmit data buffer timer 48.

Additionally, method 60 includes triggering transmission of a dormancy request to a network component based on whether the data waiting for transmission is determined to exist (Block 66). For example, in an aspect, power saving state manager 12 (FIG. 3) may cause generation and transmission of power saving request 14 to network entity 16 (FIG. 1) when data for transmission 18 is determined not to exist, which may occur immediately after the dormancy request 20 is buffered by the dormancy request frequency buffer 52. For instance, dormancy request 20 may be buffered by the dormancy request frequency buffer 52 because data for transmission 18 is determined to exist by the transmit data determiner 24, either upon receipt of dormancy request 20 at the dormancy request frequency buffer 52, or because dormancy request buffer timer 50 is active, e.g. from a prior dormancy request, when dormancy request 20 is received at the dormancy request frequency buffer 52 and no data for transmission 18 is found to exist by the transmit data determiner 24. It should be noted that in the latter case, even after dormancy request buffer timer 50 expires, the buffered dormancy request 20 triggers a check of whether data for transmission exists prior to transmitting power saving request 14.

Additionally, in an optional aspect, method 60 may further include changing current power saving state to new power saving state based on power saving state message received in response to dormancy request (Block 67). For example, power saving state manager 12 (FIG. 1 and/or state change manager 56 (FIG. 3) may receive power saving state message 26, determine new power saving state 30, and update current power saving state 32 to match new power saving state 30. In other words, the state change manager 56 receives a power saving state message 26 from the network entity 16 and this power saving state message 26 includes information to specifically indicate the new power saving state 30. The state change manager 56 then reads this message to determine the new power saving state 30 and updates current power saving state 32 to match the new power saving state 30.

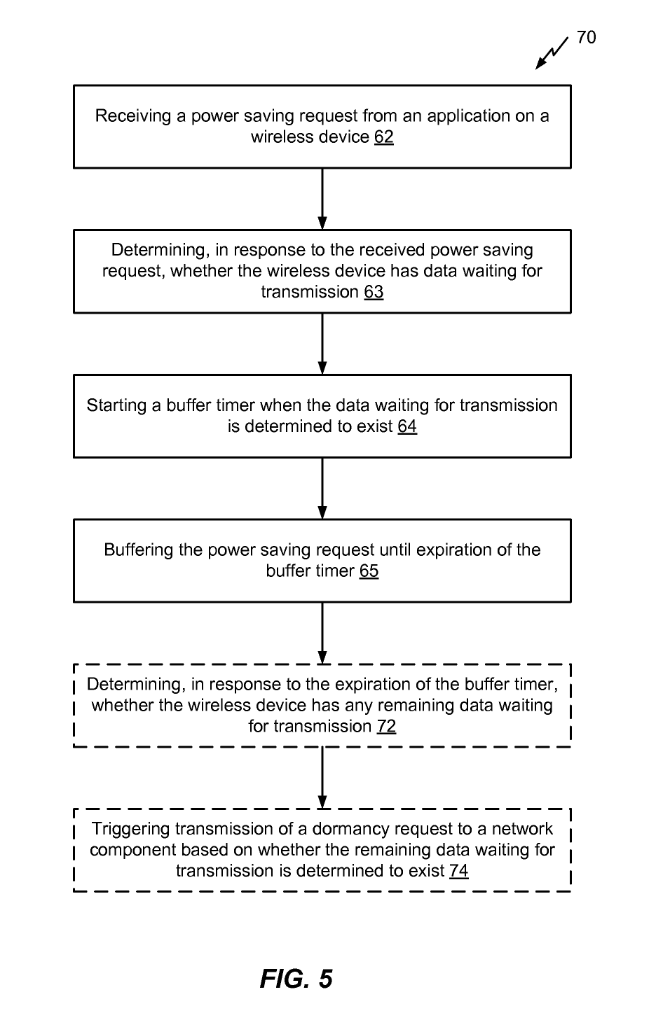

Referring to FIG. 5, after the UE receiving a power saving request from an application on a wireless device (Block 62), determines whether the wireless device has data waiting for transmission in response to the received power saving request (Block 63), starts the buffer timer when the data waiting for transmission is determined to exist (Block 64 and buffers the power saving request until expiration of the buffer timer (Block 65), the UE may optionally include additional operations. Note, the additionally operations of FIG. 5 may optionally occur when Blocks 62-65 of FIG. 4 are completed.

For instance, method 70 may additionally include determining, in response to the expiration of the buffer timer, whether the wireless device has any remaining data waiting for transmission (Block 76). For example, when a transmit data buffer timer 48 (FIG. 3) expires, the transmit data determiner 24 (FIG. 3) determines if there is remaining data waiting for transmission, e.g. data for transmission 18.

In addition, method 70 optionally includes triggering transmission of a dormancy request to a network component based on whether the remaining data waiting for transmission is determined to exist (Block 78). For example, in an aspect, power saving state manager 12 (FIG. 1) and/or request generator 54 (FIG. 3) may cause generation and transmission of power saving request 14 to network entity 16 when no remaining data for transmission 18 is determined to exist.

It should be noted that, prior to the described aspects, multiple features aimed at saving both UE battery power and also signaling overhead from a network perspective were proposed by 3GPP and other standards organization. These features have tried at their best to provide a bilateral communication between the core network and the UE to negotiate a better power saving state. These power saving features should be carefully designed, however, to make sure that they do not add to the signaling overhead and defeat the overall objective. In this case, various applications that utilize the radio resources assigned for communication can trigger requests for a power saving state without prior knowledge about the requests from other peer applications. Prior to the described aspects, such requests could, at times, flood the network with back-to-back requests and thus there arose a need to optimize such requests from the mobile terminal source.

In the 3GPP community, Release 8 Fast Dormancy (FD) is one feature that gave the mobile devices a capability to signal the network a signaling connection release indication (SCRI) message with a special cause ‘UE Requested PS Data session end’ in all RRC states and request for a better power saving state. The core network, by signaling a timer T323 in the broadcast system information, indirectly notifies a UE that it supports this FD feature with a special cause, and puts a check on flooding of SCRI requests from various applications. UTRAN on reception of a SCRI with special cause for Fast Dormancy may initiate a state transition to an efficient battery consumption RRC state that include IDLE, CELL_PCH, URA_PCH, or CELL_FACH.

In other words, instead of just releasing the signaling connection when it desires, the UE 10 has to wait for the expiration of a network configured timer (T323). Once the timer expires, the UE 10 can send a signaling connection release indication message with a new parameter that indicates “UE requested PS data session end”. At this point the network entity 16 can then decide to do nothing, to release the mobile to Idle or to put the connection into Cell-/URA-PCH state.

There might be a case where in an application A sharing the same PDP profile as that of another application B, triggers a power saving request due to unavailability of data in its buffers. When this request reaches the access stratum RRC layer, the request ensures that the T323 timer is inactive, and triggers a SCRI message with special cause ‘UE Requested PS Data session end’ to the network. The core network shall move the UE to a different RRC state that might help enhance the battery saving capability of the user equipment. Now while the T323 timer is actively running, the application B can trigger another request for dormancy due to lack of data activity and this reaches the RRC layer. The request may be buffered until the active T323 timer expires and RRC can subsequently acknowledge the buffered request by sending SCRI message with special cause to the network. The above sent SCRI message for dormancy request might not have considered the current state of data activity after T323 expiry as the RRC layer may not have an idea of the data availability across the RLC buffers.

Accordingly, such back-to-back requests that are triggered based on requests from varied applications fail to consider the current availability of data in UE buffers as, for example, the higher layers may not have insight into this information directly. This incorrect trigger would essentially defeat the whole purpose of the Fast Dormancy power saving feature and may result in unprecedented additional signaling between the user equipment and the network.

The presently discussed embodiments, disclose methods and systems for improving the 3GPP proposed Fast Dormancy power saving feature by helping avoid the above explained additional signaling overhead by carefully designing and handling power saving requests that are buffered due to an active T323 timer.

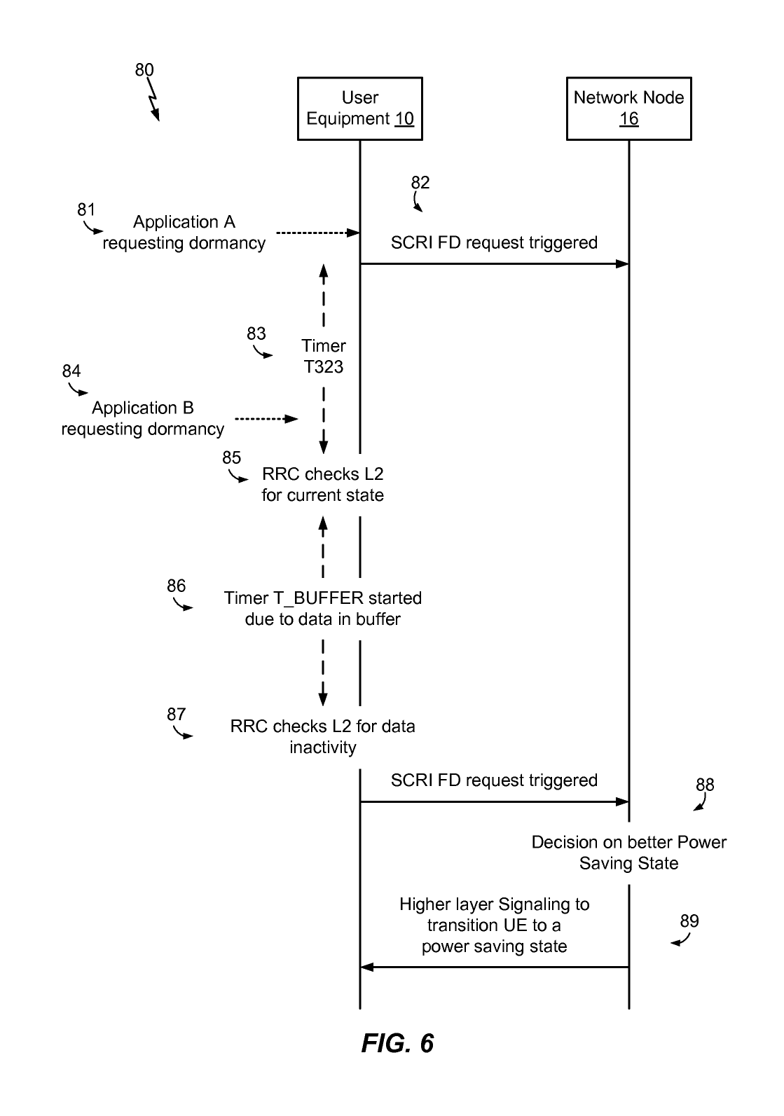

Referring to FIG. 6, the present apparatus and methods include an algorithm that, in one example, optimizes handling multiple higher layer requests for the Release 8 Fast Dormancy feature. In particular, referring to one example of a message flow 80, at 81, an Application A generates a dormancy request 20, e.g. based on data inactivity. In response, at 82, UE 10 or a component thereof, e.g. power saving state manager 12 (FIGS. 1-3), initiates and/or causes transmission of power saving request 14 (FIG. 3), such as SCRI with special cause ‘UE Requested PS Data session end,’ to network entity 16, such as a NodeB. Further, at 83, UE 10 activates dormancy request buffer timer 48 (FIG. 3), such as a T323 timer, to avoid back-to-back requests being transmitted.

At 84, if a new power saving request 14 (FIG. 1) is received from an application, such as Application B, in one aspect, UE 10 or a component thereof (e.g. power saving state manager 12 or dormancy request frequency manager 42 (FIG. 3), such as a protocol layer entity, for example an RRC entity) checks if T323 timer is currently active due to previously sent SCRI request and buffers the request if that is the case. At 85, once the T323 wait timer expires and opens the gate for further dormancy requests from UE 10, power saving state manager 12 (FIGS. 1-3) determines if data for transmission 18 (FIGS. 1-3) exist, such as but not limited to an RRC entity querying the layer 2 RLC layer for data availability in its buffers for transmission. If new data have arrived in its buffers, at 86, UE 10 or power saving state manager 12 (FIGS. 1-3) such as an RRC layer entity starts transmit data buffer timer 48 (FIG. 3), e.g. a new internal timer T_BUFFER (which may be equal to T323 timer value or an optimized value or a dynamically determined value) and waits for that period of time to check if the data in buffers have cleared transmission.

At 87, in one example, if at the expiry of the T_BUFFER period of time the RLC layer entity indicates that there is no data available in its buffers for transmission, then the RRC layer entity can trigger the buffered dormancy request. At 88, network entity 16 (FIG. 1) determines a new power saving state 30 (FIG. 1) for UE 10, and at 89 transmits power saving state message 26 (FIGS. 1 and 3) to UE 10 in order to change current power saving state 32 (FIG. 1) of UE 10. Otherwise, if data is still available for transmission at 87, then the dormancy request may be discarded considering the current state of UE 10, and power saving state manager 12 (FIGS. 1-3) may notify respective protocol layers and the requesting application.

In some aspects, the above algorithm may be applied to applications that share a PDP context. In some aspects, the above algorithm may apply for power saving requests that arrive from applications that utilize different PDP contexts. For example, this may be desired to overcome the problem in the prior art where the power saving request perceived by one application might ignore the data available for transmission for applications using a different PDP context but a same uplink radio resource.

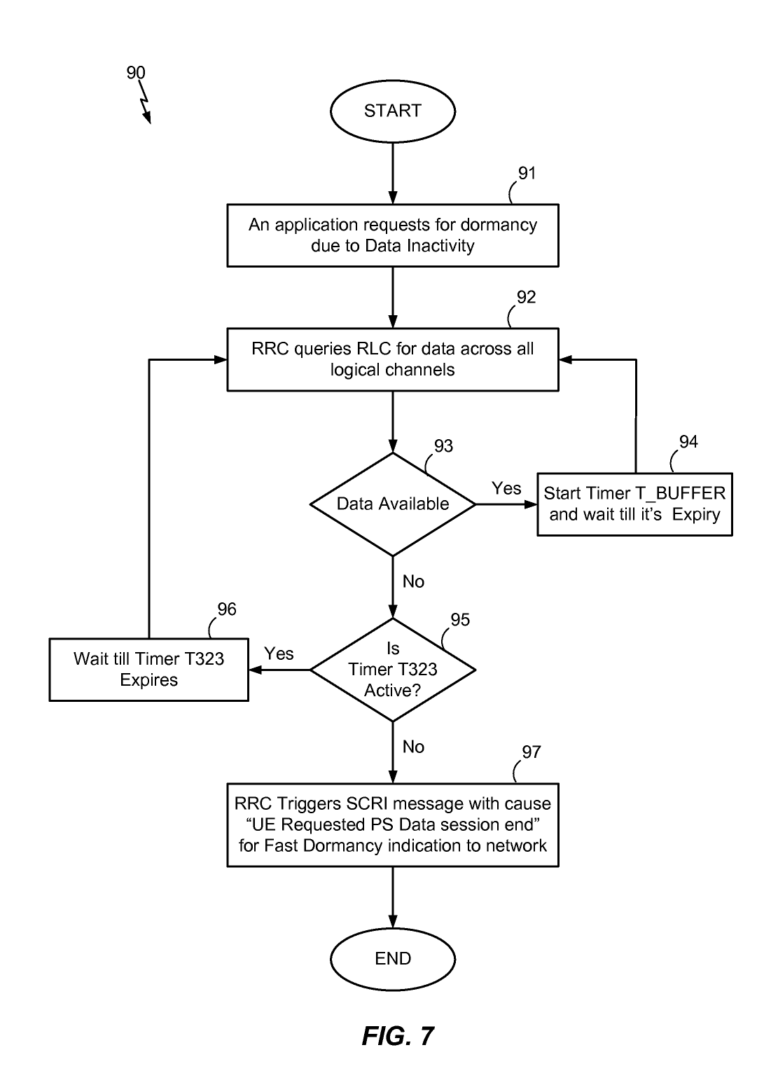

Referring to FIG. 7, in another aspect, a flowchart of a method 90 of managing power saving requests on a user equipment, such as UE 10 (FIGS. 1-3), includes an receiving a request from an application for dormancy (dormancy request 20 in FIGS. 1-3), such as due to data inactivity (Block 91). Further, in an aspect, method 90 include querying, such as by an RRC protocol layer entity to another protocol layer, such as an RLC protocol layer entity, for data available for transmission across all logical channels (Block 92). Then, method 90 determines whether or not any data for transmission 18 (FIGS. 1-3) is available (Block 93). If so, then method 90 starts a transmit data buffer timer 48 (FIG. 3), such as T_BUFFER, and waits until its expiry in order to allow UE 10 to transmit the data before attempting to change into a new power saving state (Block 94). Upon expiry of the transmit data buffer timer, method 90 again checks for and determines data availability (Blocks 92 and 93).

If no data for transmission 18 (FIGS. 1-3) is available, either initially or after expiration of transmit data buffer timer, then method 90 determines if dormancy request buffer timer 48 (FIG. 3), e.g. a T323 timer, is active (Block 95). If so, then method 90 waits for the dormancy request buffer timer 48 (FIG. 3) to expire, and repeats Blocks 92, 93 and 95. If the dormancy request buffer timer 48 (FIG. 3) is not active, either initially or after waiting for the timer to expire and re-checking for data availability, then method 90 further includes transmitting a power saving request 14 (FIG. 3) (Block 97), such as by an RRC entity triggering an SCRI message with the special cause ‘UE Requested PS Data Session End,’ e.g. for a Fast Dormancy indication to the network in UMTS Release 8.

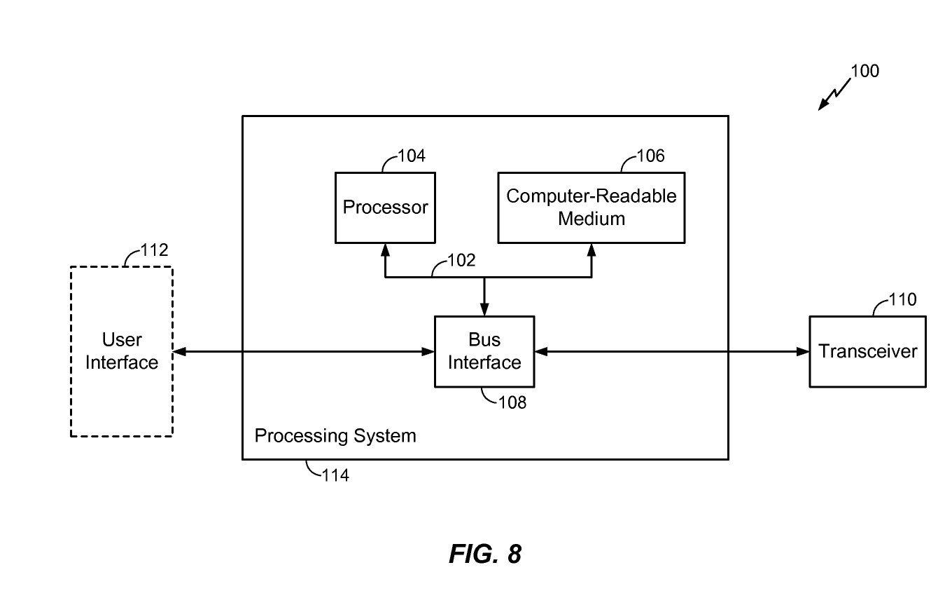

FIG. 8 is a block diagram illustrating an example of a hardware implementation for an apparatus 100 employing a processing system 114. Apparatus 100 may be, for example, UE 10 of FIGS. 1-3. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104, as will be described further below, is responsible for managing the bus 102 and general processing, including the execution of software stored on the computer-readable medium 106. The software, when executed by the processor 104, causes the processing system 114 to perform the various functions described infra for any particular apparatus. The computer-readable medium 106, as will be described further below may comprise volatile and/or non-volatile storage and may also be used for storing data that is manipulated by the processor 104 when executing software. Note, each and every element/component/module/means of FIGS. 1-3 may be implemented by processor 104 and computer-readable medium 106, which causes the processing system 114 to perform the various functions/processes/algorithms described in FIGS. 1-7.

The various concepts presented throughout this disclosure may be implemented across a broad variety of telecommunication systems, network architectures, and communication standards.

Referring to FIG. 9, by way of example and without limitation, the aspects of the present disclosure illustrated are presented with reference to a UMTS system 200 employing a W-CDMA air interface. A UMTS network includes three interacting domains: a Core Network (CN) 204, a UMTS Terrestrial Radio Access Network (UTRAN) 202, and User Equipment (UE) 210. For instance, UE 210 may be UE 10 described above with respect to FIGS. 1-3. In this example, the UTRAN 202 provides various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the RNCs 206 and RNSs 207 illustrated herein. The RNC 206 is an apparatus responsible for, among other things, assigning, reconfiguring and releasing radio resources within the RNS 207. The RNC 206 may be interconnected to other RNCs (not shown) in the UTRAN 202 through various types of interfaces such as a direct physical connection, a virtual network, or the like, using any suitable transport network.

Communication between a UE 210 and a Node B 208 may be considered as including a physical (PHY) layer and a medium access control (MAC) layer. Further, communication between a UE 210 and an RNC 206 by way of a respective Node B 208 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in the RRC Protocol Specification, 3GPP TS 25.331 v9.1.0, incorporated herein by reference.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provides wireless access points to a CN 204 for any number of mobile apparatuses 221. Examples of a mobile apparatus 221 include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus 221 is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The DL, also called the forward link, refers to the communication link from a Node B 208 to a UE 210, and the UL, also called the reverse link, refers to the communication link from a UE 210 to a Node B 208.

The CN 204 interfaces with one or more access networks, such as the UTRAN 202. As shown, the CN 204 is a GSM core network. However, as those skilled in the art will recognize, the various concepts presented throughout this disclosure may be implemented in a RAN, or other suitable access network, to provide UEs with access to types of CNs other than GSM networks.

The CN 204 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a VLR that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The CN 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 208 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 210 provides feedback to the node B 208 over the HS-DPCCH to indicate whether it correctly decoded a packet on the downlink.

HS-DPCCH further includes feedback signaling from the UE 210 to assist the node B 208 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect of the disclosure, the node B 208 and/or the UE 210 may have multiple antennas supporting MIMO technology. The use of MIMO technology enables the node B 208 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 210 to increase the data rate or to multiple UEs 210 to increase the overall system capacity. This is achieved by spatially precoding each data stream and then transmitting each spatially precoded stream through a different transmit antenna on the downlink. The spatially precoded data streams arrive at the UE(s) 210 with different spatial signatures, which enables each of the UE(s) 210 to recover the one or more the data streams destined for that UE 210. On the uplink, each UE 210 may transmit one or more spatially precoded data streams, which enables the node B 208 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

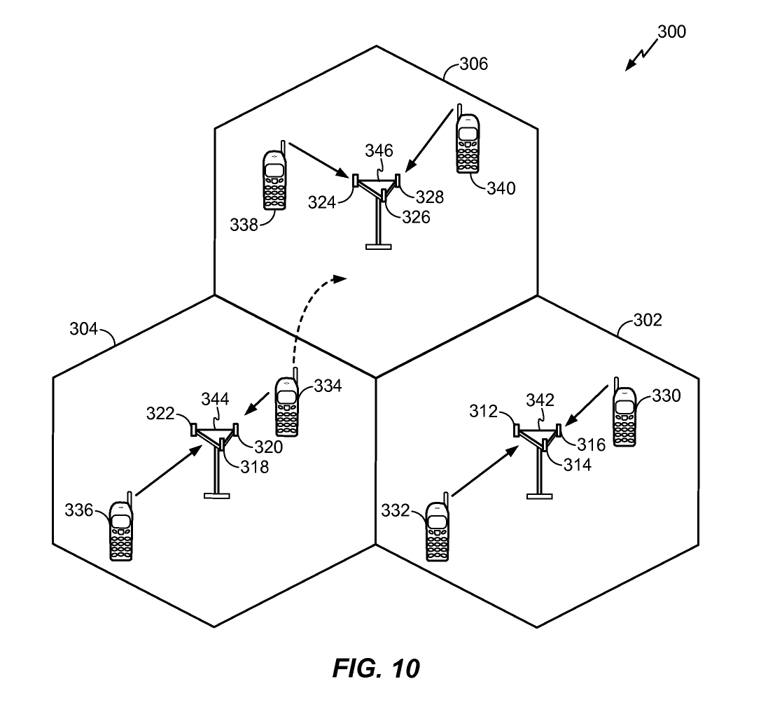

Referring to FIG. 10, an access network 300 in a UTRAN architecture is illustrated. The multiple access wireless communication system includes multiple cellular regions (cells), including cells 302, 304, and 306, each of which may include one or more sectors. The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 may include several wireless communication devices, e.g., User Equipment or UEs, which may be in communication with one or more sectors of each cell 302, 304 or 306. For example, UEs 330 and 332 may be in communication with Node B 342, UEs 334 and 336 may be in communication with Node B 344, and UEs 338 and 340 can be in communication with Node B 346. Here, each Node B 342, 344, 346 is configured to provide an access point to a CN 204 (see FIG. 9) for all the UEs 330, 332, 334, 336, 338, 340 in the respective cells 302, 304, and 306. For example, UEs 330, 332, 334, 336, 338, 340 may be UE 10 described above with respect to FIGS. 1 and 2.

As the UE 334 moves from the illustrated location in cell 304 into cell 306, a serving cell change (SCC) or handover may occur in which communication with the UE 334 transitions from the cell 304, which may be referred to as the source cell, to cell 306, which may be referred to as the target cell. Management of the handover procedure may take place at the UE 334, at the Node Bs corresponding to the respective cells, at a radio network controller 206 (see FIG. 9), or at another suitable node in the wireless network. For example, during a call with the source cell 304, or at any other time, the UE 334 may monitor various parameters of the source cell 304 as well as various parameters of neighboring cells such as cells 306 and 302. Further, depending on the quality of these parameters, the UE 334 may maintain communication with one or more of the neighboring cells. During this time, the UE 334 may maintain an Active Set, that is, a list of cells that the UE 334 is simultaneously connected to (i.e., the UTRA cells that are currently assigning a downlink dedicated physical channel DPCH or fractional downlink dedicated physical channel F-DPCH to the UE 334 may constitute the Active Set).

The modulation and multiple access scheme employed by the access network 300 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The radio protocol architecture may take on various forms depending on the particular application. An example for an HSPA system will now be presented.

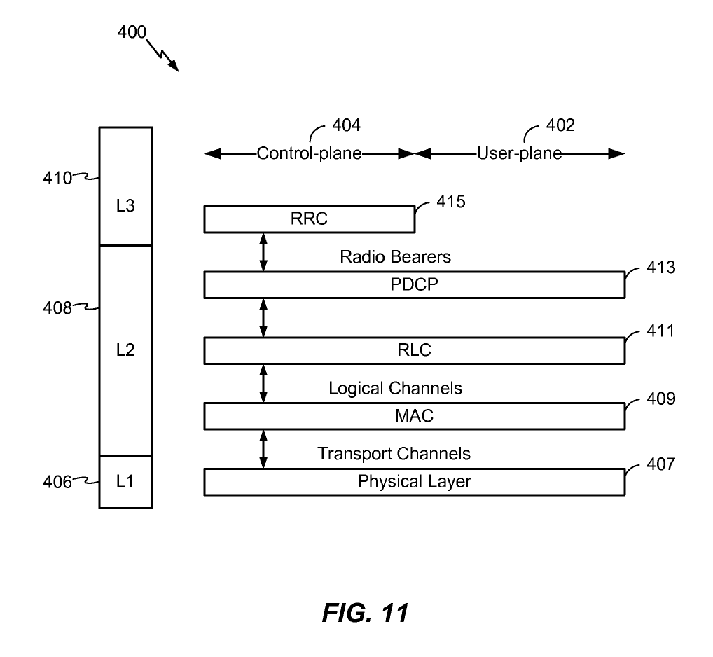

Referring to FIG. 11, an example radio protocol architecture 400 relates to the user plane 402 and the control plane 404 of a user equipment (UE) or node B/base station. For example, architecture 400 may be included in a UE such as UE 10 (FIGS. 1 and 2). The radio protocol architecture 400 for the UE and node B is shown with three layers: Layer 1 406, Layer 2 408, and Layer 3 410. Layer 1 406 is the lowest lower and implements various physical layer signal processing functions. As such, Layer 1 406 includes the physical layer 407. Layer 2 (L2 layer) 408 is above the physical layer 407 and is responsible for the link between the UE and node B over the physical layer 407. Layer 3 (L3 layer) 410 includes a radio resource control (RRC) sublayer 415. The RRC sublayer 415 handles the control plane signaling of Layer 3 between the UE and the UTRAN.

In the user plane, the L2 layer 408 includes a media access control (MAC) sublayer 409, a radio link control (RLC) sublayer 411, and a packet data convergence protocol (PDCP) 413 sublayer, which are terminated at the node B on the network side. Although not shown, the UE may have several upper layers above the L2 layer 408 including a network layer (e.g., IP layer) that is terminated at a PDN gateway on the network side, and an application layer that is terminated at the other end of the connection (e.g., far end UE, server, etc.).

The PDCP sublayer 413 provides multiplexing between different radio bearers and logical channels. The PDCP sublayer 413 also provides header compression for upper layer data packets to reduce radio transmission overhead, security by ciphering the data packets, and handover support for UEs between node Bs. The RLC sublayer 411 provides segmentation and reassembly of upper layer data packets, retransmission of lost data packets, and reordering of data packets to compensate for out-of-order reception due to hybrid automatic repeat request (HARQ). The MAC sublayer 409 provides multiplexing between logical and transport channels. The MAC sublayer 409 is also responsible for allocating the various radio resources (e.g., resource blocks) in one cell among the UEs. The MAC sublayer 409 is also responsible for HARQ operations.

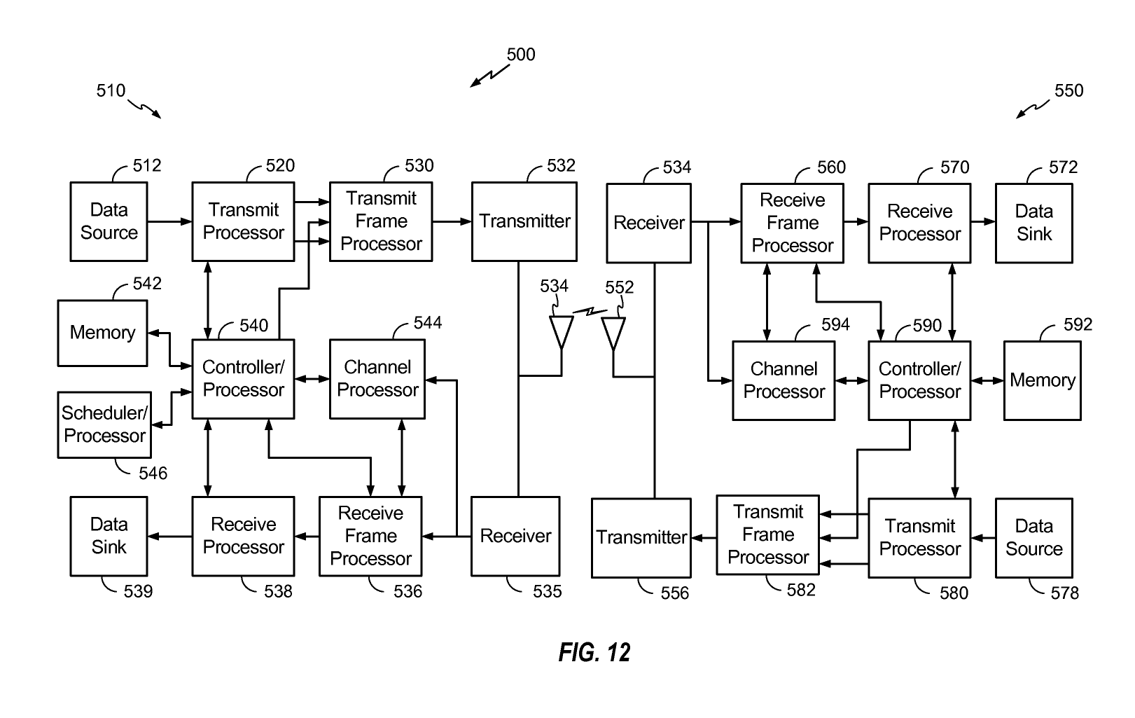

FIG. 12 is a block diagram 500 of a Node B 510 in communication with a UE 550, where the Node B 510 may be network entity 16 in FIG. 1, and the UE 550 may be the UE 10 in FIGS. 1-3. In the downlink communication, a transmit processor 520 may receive data from a data source 512 and control signals from a controller/processor 540. The transmit processor 520 provides various signal processing functions for the data and control signals, as well as reference signals (e.g., pilot signals). For example, the transmit processor 520 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 544 may be used by a controller/processor 540 to determine the coding, modulation, spreading, and/or scrambling schemes for the transmit processor 520. These channel estimates may be derived from a reference signal transmitted by the UE 550 or from feedback from the UE 550. The symbols generated by the transmit processor 520 are provided to a transmit frame processor 530 to create a frame structure. The transmit frame processor 530 creates this frame structure by multiplexing the symbols with information from the controller/processor 540, resulting in a series of frames. The frames are then provided to a transmitter 532, which provides various signal conditioning functions including amplifying, filtering, and modulating the frames onto a carrier for downlink transmission over the wireless medium through antenna 534. The antenna 534 may include one or more antennas, for example, including beam steering bidirectional adaptive antenna arrays or other similar beam technologies.

At the UE 550, a receiver 554 receives the downlink transmission through an antenna 552 and processes the transmission to recover the information modulated onto the carrier. The information recovered by the receiver 554 is provided to a receive frame processor 560, which parses each frame, and provides information from the frames to a channel processor 594 and the data, control, and reference signals to a receive processor 570. The receive processor 570 then performs the inverse of the processing performed by the transmit processor 520 in the Node B 510. More specifically, the receive processor 570 descrambles and despreads the symbols, and then determines the most likely signal constellation points transmitted by the Node B 510 based on the modulation scheme. These soft decisions may be based on channel estimates computed by the channel processor 594. The soft decisions are then decoded and deinterleaved to recover the data, control, and reference signals. The CRC codes are then checked to determine whether the frames were successfully decoded. The data carried by the successfully decoded frames will then be provided to a data sink 572, which represents applications running in the UE 550 and/or various user interfaces (e.g., display). Control signals carried by successfully decoded frames will be provided to a controller/processor 590. When frames are unsuccessfully decoded by the receiver processor 570, the controller/processor 590 may also use an acknowledgement (ACK) and/or negative acknowledgement (NACK) protocol to support retransmission requests for those frames.

In the uplink, data from a data source 578 and control signals from the controller/processor 590 are provided to a transmit processor 580. The data source 578 may represent applications running in the UE 550 and various user interfaces (e.g., keyboard). Similar to the functionality described in connection with the downlink transmission by the Node B 510, the transmit processor 580 provides various signal processing functions including CRC codes, coding and interleaving to facilitate FEC, mapping to signal constellations, spreading with OVSFs, and scrambling to produce a series of symbols. Channel estimates, derived by the channel processor 594 from a reference signal transmitted by the Node B 510 or from feedback contained in the midamble transmitted by the Node B 510, may be used to select the appropriate coding, modulation, spreading, and/or scrambling schemes. The symbols produced by the transmit processor 580 will be provided to a transmit frame processor 582 to create a frame structure. The transmit frame processor 582 creates this frame structure by multiplexing the symbols with information from the controller/processor 590, resulting in a series of frames. The frames are then provided to a transmitter 556, which provides various signal conditioning functions including amplification, filtering, and modulating the frames onto a carrier for uplink transmission over the wireless medium through the antenna 552.

The uplink transmission is processed at the Node B 510 in a manner similar to that described in connection with the receiver function at the UE 550. A receiver 535 receives the uplink transmission through the antenna 534 and processes the transmission to recover the information modulated onto the carrier. The information recovered by the receiver 535 is provided to a receive frame processor 536, which parses each frame, and provides information from the frames to the channel processor 544 and the data, control, and reference signals to a receive processor 538. The receive processor 538 performs the inverse of the processing performed by the transmit processor 580 in the UE 550. The data and control signals carried by the successfully decoded frames may then be provided to a data sink 539 and the controller/processor, respectively. If some of the frames were unsuccessfully decoded by the receive processor, the controller/processor 540 may also use an acknowledgement (ACK) and/or negative acknowledgement (NACK) protocol to support retransmission requests for those frames.

The controller/processors 540 and 590 may be used to direct the operation at the Node B 510 and the UE 550, respectively. For example, the controller/processors 540 and 590 may provide various functions including timing, peripheral interfaces, voltage regulation, power management, and other control functions. The computer readable media of memories 542 and 592 may store data and software for the Node B 510 and the UE 550, respectively. A scheduler/processor 546 at the Node B 510 may be used to allocate resources to the UEs and schedule downlink and/or uplink transmissions for the UEs. Note, controller/processors 540 and 590 may be implemented in processing system 114 of FIG. 8 as processors 104. Also note, that the computer readable media of memories 542 and 592 may be implemented in processing system 114 of FIG. 8 as computer-readable medium 106.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” or processor 104 (FIG. 8) that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 106 (FIG. 8). The computer-readable medium 106 (FIG. 8) may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of managing power saving requests, comprising:
receiving a power saving request from an application on a wireless device;
determining, in response to the received power saving request, whether the wireless device has data waiting for transmission;
starting a buffer timer when the data waiting for transmission is determined to exist;
buffering the power saving request until expiration of the buffer timer; and
triggering transmission of a dormancy request to a network component based on whether the data waiting for transmission is determined to exist.

2. The method of claim 1, further comprising:
determining, in response to the expiration of the buffer timer, whether the wireless device has any remaining data waiting for transmission; and
triggering transmission of a dormancy request to a network component based on whether the remaining data waiting for transmission is determined to exist.

3. The method of claim 1, further comprising:
checking whether a dormancy request timer is currently active due to a previously sent dormancy request; and
buffering the dormancy request when the dormancy request timer is currently active; and
wherein determining whether the wireless device has the data waiting for transmission is further in response to an expiration of the dormancy request timer.

4. The method of claim 1, wherein r the application corresponds to a packet data protocol context.

5. The method of claim 1, wherein determining whether the wireless device has the data waiting for transmission further comprises determining that the data waiting for transmission has a corresponding a PDP context.

6. The method of claim 1, wherein determining whether the wireless device has the data waiting for transmission further comprises querying, by a first entity at a first protocol layer, a second protocol layer entity at a second protocol layer for data available for transmission at the second protocol layer, wherein the first protocol layer is different from the second protocol layer.

7. The method of claim 1, wherein determining whether the wireless device has the data waiting for transmission further comprises querying, by a first entity at a first protocol layer, a second protocol layer entity at a second protocol layer for data available for transmission at the second protocol layer, wherein the first protocol layer is higher than the second protocol layer.

8. The method claim 1, further comprising:
changing a current power saving state to new power saving state based on a power saving state message received in response to the dormancy request.

9. An apparatus for wireless communication, comprising:
means for receiving a power saving request from an application on a wireless device;
means for determining, in response to the received power saving request, whether the wireless device has data waiting for transmission;
means for starting a buffer timer when the data waiting for transmission is determined to exist;
means for buffering the power saving request until expiration of the buffer timer; and
means for triggering transmission of a dormancy request to a network component based on whether the data waiting for transmission is determined to exist.

10. The apparatus of claim 9, further comprising: at
means for determining, in response to the expiration of the buffer timer, whether the wireless device has any remaining data waiting for transmission; and
means for triggering transmission of a dormancy request to a network component based on whether the remaining data waiting for transmission is determined to exist.

11. The apparatus of claim 9, further comprising:
means for checking whether a dormancy request timer is currently active due to a previously sent dormancy request; and
means for buffering the dormancy request when the dormancy request timer is currently active; and
wherein determining whether the wireless device has the data waiting for transmission is further in response to an expiration of the dormancy request timer.

12. The apparatus of claim 9, wherein receiving the power saving request further comprises receiving the power saving request from the application corresponding to a packet data protocol context.

13. The apparatus of claim 9, wherein determining whether the wireless device has the data waiting for transmission further comprises determining that the data waiting for transmission has a corresponding PDP context.

14. The apparatus of claim 9, wherein determining whether the wireless device has the data waiting for transmission further comprises querying, by a first entity at a first protocol layer, a second protocol layer entity at a second protocol layer for data available for transmission at the second protocol layer, wherein the first protocol layer is different from the second protocol layer.

15. The apparatus of claim 9, wherein determining whether the wireless device has the data waiting for transmission further comprises querying, by a first entity at a first protocol layer, a second protocol layer entity at a second protocol layer for data available for transmission at the second protocol layer, wherein the first protocol layer is higher than the second protocol layer.

16. The apparatus claim 9, further comprising:
means for changing a current power saving state to new power saving state based on a power saving state message received in response to the dormancy request.

17. A computer-readable medium comprising code executable by a computer to:
receive a power saving request from an application on a wireless device;
determine, in response to the received power saving request, whether the wireless device has data waiting for transmission;
start a buffer timer when the data waiting for transmission is determined to exist;
buffer the power saving request until expiration of the buffer timer; and
trigger transmission of a dormancy request to a network component based on whether the data waiting for transmission is determined to exist.

18. The computer program product of claim 17, further comprising code executable by a computer to:
determine, in response to the expiration of the buffer timer, whether the wireless device has any remaining data waiting for transmission; and
trigger transmission of a dormancy request to a network component based on whether the remaining data waiting for transmission is determined to exist.

19. An apparatus for wireless communication, comprising:
at least one processor; and
a memory coupled to the at least one processor,
wherein the at least one processor is configured to:
receive a power saving request from an application on a wireless device;
determine, in response to the received power saving request, whether the wireless device has data waiting for transmission;
start a buffer timer when the data waiting for transmission is determined to exist;
buffer the power saving request until expiration of the buffer timer; and
trigger transmission of a dormancy request to a network component based on whether the data waiting for transmission is determined to exist.

20. The apparatus of claim 19, wherein the processor is further configured to:
determine, in response to the expiration of the buffer timer, whether the wireless device has any remaining data waiting for transmission; and
trigger transmission of a dormancy request to a network component based on whether the remaining data waiting for transmission is determined to exist.

21. The apparatus of claim 20, wherein the processor is further configured to:
check whether a power saving request timer is currently active due to a previously sent power saving request; and
buffer the power saving request when the power saving request timer is currently active; and
wherein determining whether the wireless device has the data waiting for transmission is further in response to an expiration of the power saving request timer.

22. The apparatus of claim 20, wherein receiving the power saving request further comprises receiving the power saving request from the application corresponding to a packet data protocol context.

23. The apparatus of claim 20, wherein determining whether the wireless device has the data waiting for transmission further comprises determining the data waiting for transmission for at least one of a same packet data protocol context or for a different packet data protocol context

24. The apparatus of claim 20, wherein determining whether the wireless device has the data waiting for transmission further comprises querying, by a first entity at a first protocol layer, a second protocol layer entity at a second protocol layer for data available for transmission at the second protocol layer, wherein the first protocol layer is different from the second protocol layer.

25. The apparatus of claim 20, wherein determining whether the wireless device has the data waiting for transmission further comprises querying, by a first entity at a first protocol layer, a second protocol layer entity at a second protocol layer for data available for transmission at the second protocol layer, wherein the first protocol layer is higher than the second protocol layer.

26. The apparatus of claim 20, wherein the processor is further configured to:
change a current power saving state to new power saving state based on a power saving state message received in response to the dormancy request.
